(19) United States
(12) Patent Application Publication
(10) Pub. No.: US 2026/0094350 A1
(43) Pub. Date: Apr. 2, 2026

(54) COMPUTER-IMPLEMENTED METHOD OF GENERATING, FOR USE IN A RENDERING PROCESS, A REPRESENTATION OF A VOLUMETRIC DATASET REPRESENTING A MEDICAL VOLUME

(71) Applicant: Siemens Healthineers AG, Forchheim (DE)

(72) Inventors: Klaus ENGEL, Nuernberg (DE); Martin KRAUS, Fuerth (DE)

(73) Assignee: Siemens Healthineers AG, Forchheim (DE)

(21) Appl. No.: 19/340,983

(22) Filed: Sep. 26, 2025

(30) Foreign Application Priority Data
Sep. 27, 2024 (DE) 10 2024 209 461.7

(51) Int. Cl. G06T 15/08; G06T 3/40; G06T 15/20

(52) U.S. Cl. CPC G06T 15/08; G06T 3/40; G06T 15/20; G06T 2210/41

(57) ABSTRACT

A computer-implemented method of generating, for a rendering process, a representation of a volumetric dataset representing a medical volume is described. The method comprises generating a plurality of sets of functions representing the volumetric dataset in different respective rendering configurations and determining, based on the plurality of sets of functions, given functions having a respective 3D location with respect to the volumetric dataset and a respective one or more visual attribute values to be stored in the representation. The given functions are stored in the representation in association with selection data configured to allow selection, during the rendering process, of one or more of the given functions for use in the rendering process. The selection data is based on one or more of the rendering configurations. A computer-implemented method of rendering an image of a volumetric dataset representing a medical volume using such a representation is also described.

### CROSS-REFERENCE TO RELATED APPLICATION(S)

The present application claims priority under 35 U.S.C. § 119 to German Patent Application No. 10 2024 209 461.7, filed Sep. 27, 2024, the entire contents of which are incorporated herein by reference.

### TECHNICAL FIELD

One or more example embodiments relates to a computer-implemented method of generating, for use in a rendering process, a representation of a volumetric dataset representing a medical volume. One or more example embodiments also relates to a method of rendering an image of a volumetric dataset representing a medical volume using such a representation. Further, one or more example embodiments relates to an apparatus and a set of machine-readable instructions for implementing either method, and a machine-readable medium comprising such instructions.

### RELATED ART

In computer-implemented imaging of medical volume data, making interactive high-quality visualizations of medical data readily available may face challenges with data size, especially when rendering data generated by high-resolution imaging modalities, such as 7T MRI, photon-counting CT and phase-contrast CT. The enormous data amounts produced by these imaging modalities may present challenges in transferring and/or rendering the image data due, for example, to limited bandwidths, limited rendering power and memory size limitations. Such issues may be particularly apparent in the context of clinical workflows and anatomy learning platforms where computing and time resources may be limited.

### SUMMARY

According to one or more example embodiments, there is provided a computer-implemented method of generating, for use in a rendering process, a representation of a volumetric dataset representing a medical volume. The method comprises: generating a plurality of sets of functions representing a volumetric dataset in different respective rendering configurations determining, based on the plurality of sets of functions, given functions having a respective 3D location with respect to the volumetric dataset and a respective one or more visual attribute values to be stored in a representation of the volumetric dataset to be used in a rendering process; and storing, in the representation of the volumetric dataset, the given functions in association with selection data configured to allow selection, during the rendering process, of one or more of the given functions for use in the rendering process, wherein the selection data is based on one or more of the rendering configurations.

The different rendering configurations may comprise a first rendering configuration representing a first portion of the volumetric dataset at a first resolution, and a second rendering configuration representing a second portion of the volumetric dataset different to the first portion at a second resolution higher than the first resolution.

The given functions may be Gaussian functions, and the representation of the volumetric dataset may be a Gaussian splat representation.

One or more of the different rendering configurations may differ with respect to one another with respect to one or more of: a clip plane setting; a transfer function setting; a lighting setting; and a bounding box setting.

The method may comprise comparing one or more functions of different sets of the plurality of sets of functions; and the determining the given functions to be stored in the representation of the volumetric dataset may be based on a result of the comparing.

The comparing may comprise determining respective similarities between functions of the different sets of functions, and the determining the one or more given functions may be based on the determined similarities.

The volumetric dataset may be a 4D volumetric dataset, and the different rendering configurations may represent different timesteps of the 4D volumetric dataset.

The generating the plurality of sets of functions may comprise: generating each set of the plurality of sets of functions based on a respective plurality of rendered images showing from different viewpoints the volumetric dataset in a given rendering configuration.

The method may comprise generating the plurality of sets of rendered images using a respective rendering process having one or more respective rendering parameters. The method may comprise determining the selection data based on one or more of the respective rendering parameters.

The method may comprise determining combinations of viewpoint and respective rendering configurations of the different rendering configurations which are configured to provide, when used in a rendering process, images which differ from one another with respect to a visible aspect of the volumetric dataset; and determining, based on the determined combinations, the respective different viewpoints for the respective plurality of images showing the volumetric dataset in the given rendering configuration.

One or more of the respective rendering processes may be a physically based rendering process.

According to one or more example embodiments, there is provided a computer-implemented method of rendering an image of a volumetric dataset representing a medical volume. The method comprises: performing a rendering process using a representation of a volumetric dataset representing a medical volume, the representation of the volumetric dataset comprising given functions having a respective 3D location with respect to the volumetric dataset and a respective one or more visual attribute values; wherein the given functions are stored in the representation in association with selection data configured to allow selection, during the rendering process, of one or more of the given functions for use in the rendering process; and wherein the rendering process comprises: selecting, based on the selection data and one or more parameters of the rendering process, one or more functions of the given functions for use in the rendering process; and rendering an image of the volumetric dataset using the selected one or more functions of the given functions.

According to one or more example embodiments, there is provided a set of machine-readable instructions which when executed by a processor cause a method according to one or more example embodiments to be performed.

According to one or more example embodiments, there is provided a machine-readable medium comprising: a representation of a volumetric dataset representing a medical volume, the representation being generatable by a method according to one or more example embodiments; and/or a set of machine-readable instructions according to one or more example embodiments.

According to one or more example embodiments, there is provided apparatus comprising: a processor; and a storage comprising: a representation of a volumetric dataset representing a medical volume, the representation being generatable by a method according to one or more example embodiments; and/or a set of machine-readable instructions according to one or more example embodiments.

### BRIEF DESCRIPTION OF THE DRAWINGS

Example embodiments of the present invention will now be described, with reference to the following figures, in which:

FIG. 1 is a flow chart illustrating a computer-implemented method of generating, for use in a rendering process, a representation of a volumetric dataset representing a medical volume according to one or more example embodiments;

FIG. 2 is a flow chart illustrating a computer-implemented method of rendering, using a representation generated by a method according to FIG. 1, an image of a volumetric dataset according to one or more example embodiments;

FIG. 3 is a schematic drawing illustrating aspects of the example method according to FIG. 1; and

FIG. 4 is a schematic drawing showing an apparatus for performing example methods described herein according to one or more example embodiments.

### DETAILED DESCRIPTION

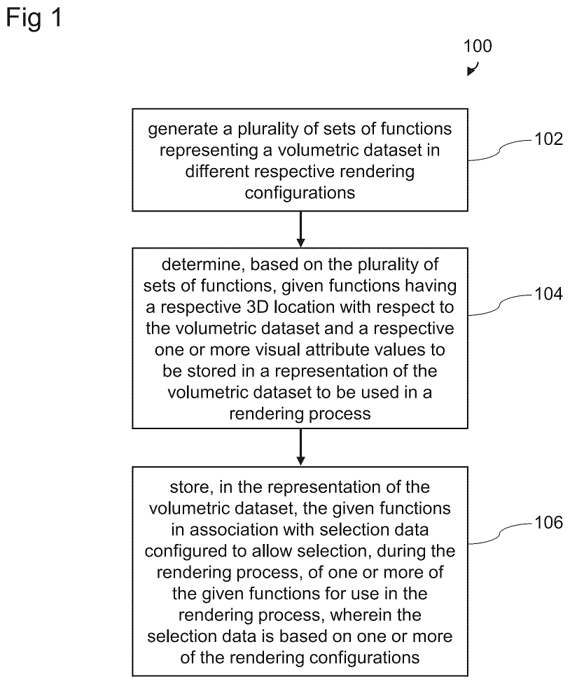

FIG. 1 is a flow chart illustrating an example computer-implemented method 100 of generating, for use in a rendering process, a representation of a volumetric dataset representing a medical volume.

The volumetric dataset may comprise a discrete sampling of a scalar field. The volumetric dataset may, for example, be obtained by loading from a memory, sensors, and/or other sources. The medical volume represented by the volumetric dataset may, for example, include a patient or a part of a patient, for example, a human or animal patient.

In general, any suitable scanning modality may be used to produce the volumetric dataset. For example, the scanning modality may comprise the use of computed tomography (CT), magnetic resonance imaging (MRI) or positron emission tomography (PET). In some examples, the scanning modality may comprise a high-resolution imaging modality, such as 7T MRI, photon-counting CT or phase-contrast CT. In some examples a scanning modality comprising the use of single photon emission computed tomography (SPECT), ultrasound, or another scan modality may be used. In some examples, the volumetric dataset may include data from multiple such scanning modalities. For example, multiple sets of volume data, such as PET, CT and MRI may be fused to provide the volumetric dataset. Scan data may be provided in the form of multiple two-dimensional (2D) scans or may be formatted from a scan. In some examples, the volumetric dataset may comprise a stack of 2D image slices. The 2D image slices may comprise compressed slice data, for example, in JPEG2000 format. In some examples, the volumetric dataset is a DICOM dataset created by scanning at least a portion of a patient using one or more scanning modalities.

The volumetric dataset may comprise data formatted as a plurality of voxels. The voxels may, for example, be in a uniform or non-uniform grid, or may be arranged in some other type of geometry (e.g., polar coordinate format). The voxels may be isotropic or anisotropic. Each voxel may typically represent a scalar value obtained by sampling a scalar field, although in some examples the volumetric dataset may comprise data relating to a non-scalar field. The type of value represented by each voxel may be dependent on the means by which the volumetric dataset is obtained. For example, where a CT scanner is used to produce the volumetric dataset, the dataset may comprise Hounsfield values. The values represented by each voxel may be represented at a given precision, for example, 8-bit or 16-bit.

In some examples, the volumetric dataset may be a 4D volumetric dataset. For example, the volumetric dataset may comprise a series of 3D volume data sets with each set representing the medical volume at a different timestep. Each 3D volume data set may have any of the features described above for example volumetric datasets.

At block 102, the method 100 comprises generating a plurality of sets of functions representing the volumetric dataset in different respective rendering configurations.

The different rendering configurations may, for example, differ with respect to one or more of: a clip plane setting; a transfer function setting; a lighting setting; or a bounding box setting. Additionally, or alternatively, the different rendering configurations may relate to different timesteps in a 4D volumetric dataset.

For example, in one example, the different rendering configurations represent different portions of the volumetric dataset. The different portions of the volumetric dataset may be represented at different resolutions. For example, in a first rendering configuration, a first portion of the volumetric dataset, e.g., representing an entirety of the medical volume, may be represented at a first resolution, while, in a second rendering configuration, a second portion of the volumetric dataset, e.g., representing a region of interest of the medical volume, may represented at a second resolution. The first and second portions of the volumetric dataset may correspond with different respective bounding box settings. The second resolution may be higher than the first resolution, for example, such that certain regions of interest of the volumetric dataset are represented at higher resolution.

In another example, in a first rendering configuration the volumetric dataset may be represented with a first clip-plane setting. A second rendering configuration may correspond with a second clip-plane setting. For example, a given clip plane may be placed in a different position in the second rendering configuration compared with its position in the first rendering configuration.

In other examples, any other parameter or any combination of parameters may differ between the different rendering configurations.

Generating the plurality of sets of functions representing the volumetric dataset in the different rendering configurations may comprise generating each set of the plurality of sets of functions based on a respective plurality of rendered images. The plurality of images may show, from different viewpoints, the volumetric dataset in the given rendering configuration.

As an example, a first plurality of images used to generate a first of the sets of functions may show, from a plurality of different viewpoints, the volumetric dataset in a first rendering configuration. The first rendering configuration may correspond to a first set of rendering parameters for a rendering process used to render the first plurality of images of the volumetric dataset. For example, the first rendering configuration may correspond with a first given combination of bounding box, clip-plane, and transfer function settings used in a rendering process to generate the first plurality of images.

The images showing the volumetric dataset in a given rendering configuration may be generated by performing a rendering process using a given set of rendering parameters. The rendering process may, for example, be a physically based rendering process. For example, the rendering process may be a path-tracing process. In other examples, the rendering process may be a non-physically based rendering process, for example, a ray-casting process. The rendering process may be repeated from a plurality of different viewpoints to obtain the images of the volumetric dataset in the given rendering configuration. This process may be repeated for one or more other rendering configurations to obtain respective pluralities of images showing the volumetric dataset in each of the different rendering configurations. For example, different bounding box settings may be used to render different portions of the volumetric dataset, e.g., with different resolutions, different clip-plane settings may be used to render the volumetric dataset with a different clip-plane position or orientation, and/or different transfer function settings may be used to render the volumetric dataset with different visual characteristics.

A given set of functions generated at block 102 provides a representation of the volumetric dataset in the given rendering configuration to which the given set of functions corresponds. For example, a given set of high-fidelity images may be rendered, e.g., using a path-tracing process, showing the volumetric dataset in given rendering configuration from a limited number of angles. A set of functions may be generated from the plurality of images providing a 3D representation of the volumetric dataset in the given rendering configuration. These functions may be usable in a rendering process, e.g., a rasterization process, to render images of the volumetric dataset in the given rendering configuration from any given angle. The functions may provide a compact representation of the volumetric dataset in the given rendering configuration. For example, the set of functions may occupy substantially less space when stored than the volumetric dataset itself.

In the rendering configuration of the volumetric dataset used to render the images for generating a given set of functions, the volume may be segmented, and color, opacity and segmentation mask specific transfer functions may be applied.

In some examples, a set of functions representing the volumetric dataset in a given rendering configuration may be a point-cloud representation. That is, each function may form a point in a point cloud having a 3D location with respect to the volumetric dataset. Each function may have one or more visual attribute values, such as, shape, color, and opacity.

In certain such examples, the set of functions representing the volumetric dataset in a given rendering configuration is a set of Gaussian functions forming a Gaussian splat representation of the volumetric dataset in the given rendering configuration. In an example where a given set of functions is a Gaussian splat comprising a set of Gaussian functions, each function may include the following parameters.

A mean μ, which may be interpretable as a 3D location in the volumetric dataset, e.g., comprising x, y, z Cartesian co-ordinates;

A covariance Σ, which may be interpretable as a shape of the Gaussian function;

An opacity σ(□), which may be a sigmoid function is applied to map the parameter to the [0, 1] interval.

One or more color parameters, for example, three values for (R, G, B) or spherical harmonics coefficients.

A set of such Gaussian functions representing the volumetric dataset in a given rendering configuration may be obtained by performing a training process using the images showing the volumetric dataset in the given rendering configuration. The training process may involve using a differentiable rendering method to optimize the parameters of the Gaussian functions and the number of Gaussian functions in the set, e.g., using a gradient descent technique. For example, the training process may involve initializing a set of Gaussian functions representing the rendering configuration and rendering images from the set of Gaussian functions using a rasterization technique. The rasterization technique may involve GPU sorting and rasterization of projected 2D Gaussians, and the use of a pixel shader to evaluate and blend the 2D projections in the image space. In one particular example rasterization method for rendering from a Gaussian splat representation, the screen space is tiled and the Gaussian functions visible in the view frustum for each tile are determined. These Gaussian functions are then labelled according to their depth. For each tile, the associated Gaussian functions are loaded into memory and for a given pixel color and alpha (i.e. opacity) values are accumulated by traversing the associated Gaussian functions front-to-back in terms of depth until a target saturation of alpha for the pixel.

The images rendered from the Gaussian functions may be compared with the original rendered images of the volumetric dataset in the given rendering configuration. The parameters of the Gaussian functions may be adjusted to better represent the original images. Successive iterations of this process may be performed to optimize the set of Gaussian functions for representing the volumetric dataset in the given rendering configuration, for example, using a stochastic gradient descent technique. Generating a set of Gaussian functions representing a given rendering configuration may, for example, use any of the techniques described in the paper: 3D Gaussian Splatting for Real-Time Radiance Field Rendering, Bernhard Kerbl, Georgios Kopanas, Thomas Leimkühler, George Drettakis, SIGGRAPH 2023, (ACM Transactions on Graphics) and/or in the paper Compressed 3D Gaussian Splatting for Accelerated Novel View Synthesis, Simon Niedermayr, Josef Stumpfegger, Rüdiger Westermann, CVPR 2024.

At block 104, the method 100 comprises, determining, based on the plurality of sets of functions, given functions to be stored in a representation of the volumetric dataset to be used in a rendering process. The given functions to be stored have a respective 3D location with respect to the volumetric dataset and a respective one or more visual attribute values, such as, color, shape, or opacity.

In some examples, the given functions to be stored in the representation of the volumetric dataset are functions of the plurality of sets of functions generated at block 102. For example, the given functions may be selected from the functions of the plurality of sets of functions generated at block 102. The given functions may be Gaussian functions and the representation of the volumetric dataset in which the given functions are stored may be a Gaussian splat representation.

In an example where a first set of functions of the plurality of sets of functions represents a first portion of the volumetric dataset at a first resolution and a second set of functions of the plurality of sets of functions represents a second portion of the volumetric dataset at a second resolution, one or more functions of each of the first set and second set may be determined as functions to be stored in the representation of the volumetric dataset. In some such examples, some or all of the functions of the first and second sets of functions may be selected as functions to be stored in the representation.

In some examples, the representation of the volumetric dataset may comprise different subsets of functions representing the volumetric dataset in different rendering configurations. As an example, in an example such as that described above in which first and second rendering configurations represent the volumetric dataset with different clip-plane settings, a first subset of the given functions may represent the volumetric dataset in the first rendering configuration having a first clip-plane setting, and a second subset of the given functions may represent the volumetric dataset in the second rendering configuration having a second clip-plane setting. Similarly, where the volumetric dataset is a 4D dataset comprising different timesteps, a first subset of the given functions may represent the first timestep of the volumetric dataset and a second subset of the given functions may represent the second timestep of the volumetric dataset.

In some examples, the given functions to be stored may be determined by comparing functions of the multiple sets of functions representing the different rendering configurations. The determining, at block 104, the given functions to be stored in the representation of the volumetric dataset may be based on a result of the comparing.

For example, the comparing may comprise determining respective similarities between functions of the different sets of functions. The functions to be stored in the representation may be determined based on the determined similarities.

As an example, functions of a second set of functions representing a first rendering configuration may be compared with functions of a first set of functions representing a second rendering configuration to determine their similarities. Any functions of the second set of functions which are determined to have a given level of similarity, e.g. a similarity metric above a given threshold, with a function of the first set of functions may be identified. In one such example, all of the functions of the first set of functions may be determined as a first subset of the given functions to be stored. Meanwhile, of the second set of functions, only those functions which do not meet the given level of similarity with respect to the functions of the first set of functions (or, in other words, are sufficiently different from the functions of the first set of functions) are determined as a second subset of the given functions to be stored. In this manner, the second subset of the given functions may more efficiently represent the second rendering configuration by only encoding a difference between the second rendering configuration and the first rendering configuration. In some examples, such a technique may be used to determine the given functions for representing, in an efficient manner, different rendering configurations which may, for example, represent different clip plane settings, different bonding box or transfer function settings, different timesteps in a 4D volumetric dataset, or any more than one of these in combination. Examples of such techniques will be described below in more detail.

In some examples, certain of the functions to be stored may not be functions selected from the different sets of functions representing different rendering configurations but may be determined from the different sets of functions in another way. For example, two or more functions of the different sets of functions may be used to determine a given function to be stored. For example, a function from a first set of functions and a function from a second set of functions may be blended to obtain a given function to be stored in the representation of the volumetric dataset.

At block 106, the method 100 comprises storing, in the representation of the volumetric dataset, the given functions in association with selection data. The selection data is configured to allow selection, during the rendering process, of one or more of the given functions for use in the rendering process. The selection data is based on one or more of the rendering configurations.

In some examples, the selection data includes a respective label for each function of the given functions. Each label may be used to determine whether the given function is to be selected when rendering images from the representation of the volumetric dataset. For example, each function may be stored in association with a label which indicates a subset of the given functions to which it belongs. For example, where the given functions include functions representing respective portions of the volumetric dataset at different resolutions, each function may be labelled according to the portion of the volumetric dataset it represents and/or the resolution to which it corresponds. In some such examples, the functions representing the different portions of the volumetric dataset at different resolutions may be arranged in a hierarchy, with each function being labelled according to a level in the hierarchy to which it corresponds. Alternatively, or additionally, a given function may be labelled according to a timestep in a sequence of timesteps to which it corresponds, or any other one or more parameter settings, such as, a clip-plane setting, transfer function setting, or lighting setting.

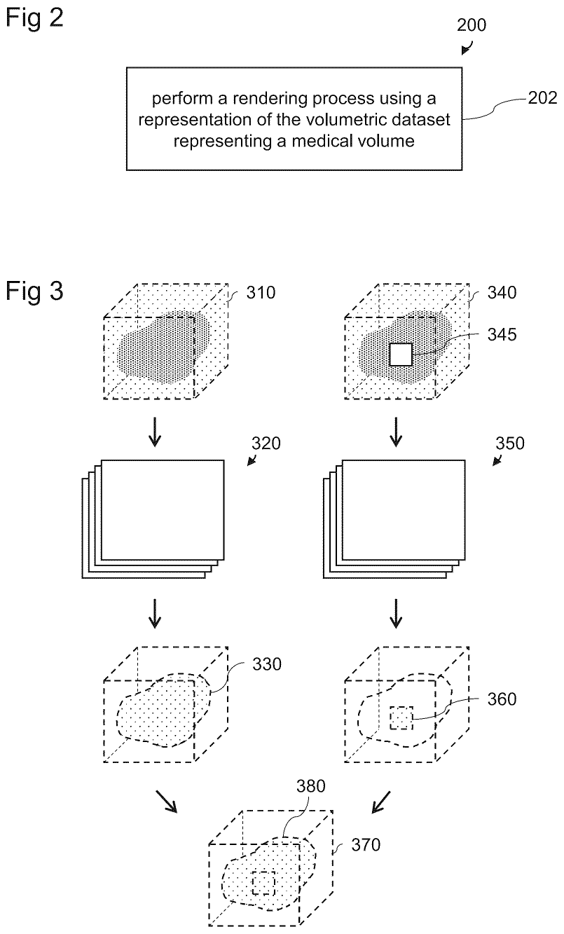

FIG. 2 is a flow chart illustrating an example computer-implemented method 200 of rendering an image of a volumetric dataset representing a medical volume. The method 200 comprises, at block 202, performing a rendering process using a representation of the volumetric dataset. The representation of the volumetric dataset may have any of the features described above of the representation generated by the method 100 of FIG. 1. The representation may have been generated by a method 100 described according to FIG. 1.

In an example, the rendering process comprises selecting, based on the selection data and one or more rendering parameters of the rendering process, one or more functions of the given functions. The selected one or more functions may be used to generate visual parameter values for an image of the volumetric dataset.

The rendering parameters of the rendering process used to select the one or more functions may, for example, correspond to any setting representing a particular rendering configuration in which the volumetric dataset is to be viewed. For example, any one or more of a clip-plane setting, transfer function setting, or a setting indicative of a region of the volumetric dataset to be visualized, for example, a bounding box setting or a zoom setting, may be used to select one or more of the functions with which to render an image. Alternatively, or additionally, a rendering parameter indicative of a timestep of a 4D volumetric dataset to be visualized may be used to select from the given functions.

The selected functions may be used to generate an image by use of any suitable rendering process. In one example, the rendering process involves a rasterization process. The rasterization process may have any of the features described above with respect to the rasterization process used in the generating of the different sets of functions upon which the functions stored in the representation are based.

Since the given functions are stored in the representation of the volumetric dataset in association with the selection data, during the rendering process appropriate functions for visualizing the volumetric dataset in a given rendering configuration can be selected. For example, a user may adjust the rendering parameters by zooming into or otherwise selecting regions of interest in the volumetric dataset. An appropriate rendering parameter, such as the zoom level or selected bounding box setting, may then be used to select, based on the selection data, the given functions to be used to render an image of the region of interest. As another example, a user may adjust a clip-plane setting and the clip-plane setting may be used to select, based on the selection data, the given functions suitable for representing the volumetric dataset with the desired clip-plane setting. As yet another example, during a visualization of 4D volume data, a timestep setting denoting a timestep to be visualized may be adjusted, and the timestep setting may be used to select the given functions representing the volumetric dataset at the given timestep.

In this manner, a compact representation of a volumetric dataset may be provided to allow a user to visualize the volumetric dataset in a computationally and storage-efficient manner while also providing for a high level of interactivity for the visualization.

The functions providing the representation of the volumetric dataset may be such that they provide a representation which is compact in terms of storage and allows for fast rendering of images of the volumetric dataset in a given rendering configuration from arbitrary viewpoints. For example, the functions may provide respective Gaussian splat representations of the volumetric dataset in multiple different rendering configurations. The selection data may allow for the visualization to be interactive by allowing appropriate functions to be selected to visualize the volumetric dataset in a desired rendering configuration. The rendering configuration to be visualized may be selected by the user or otherwise adjusted during rendering, e.g., by changing a rendering parameter of the rendering process used to render the images.

Since the representation of the volumetric dataset may be of reduced size compared with the volumetric dataset itself, this may allow for the representation of the volumetric dataset to be transferred to devices where it might be impractical or not possible to provide the entirety of the volumetric dataset, for example, due to limited storage or bandwidth. Moreover, in some examples, the representation may allow for a high-quality visualizations to be rendered by devices having limited rendering power or memory size limitations, since the device may render a high-quality visualization from the representation, e.g., using a rasterization process, without performing a more computationally intensive rendering process, such as path tracing.

As such, according to some examples, high-quality interactive visualizations of even the largest volumetric datasets may be provided on devices such as mobile devices, immersive devices such as light field displays and AR/VR headsets. This may provide for improved portability of such visualizations, for example, by allowing for an interactive high-quality visualization to be generated by a mobile device of a surgeon in an operating room or for learning and exploration by students on a webpage, social media or personal mobile or immersive display device. Alternatively, even for powerful rendering devices capable of handling large volumetric datasets and performing high-quality, e.g. path-tracing based, rendering, methods described herein may provide benefits in terms of reduced storage and computation requirements for generating high-quality interactive visualizations. For example, such visualizations may be generated in less time and with decreased memory usage requirements compared with when using more computationally intensive rendering processes.

FIG. 3 is a schematic drawing showing aspects of an example method according to FIG. 1 for generating a representation of a volumetric dataset.

In the example of FIG. 3, in a first step, parameters are set for performing a rendering process on a volumetric dataset representing medical volume data. The rendering process may, for example, be a physically based rendering process, such as a Monte Carlo path-tracing method. The parameters may comprise one or more of bounding box settings, transfer function settings, lighting settings, and clip-plane settings for the rendering process. These parameters provide a first rendering configuration of the volumetric dataset. The first rendering configuration 310 may be a rendering configuration of the volumetric dataset configured to allow certain visual information about the volumetric dataset to be conveyed. For example, the volumetric dataset may represent a heart of a patient and the first rendering configuration 310 may be defined by an appropriate bounding box enclosing the region to be included in the visualization, as well as suitable transfer function, lighting, and other settings for providing a representation of the heart which conveys relevant visual information to a viewer. As an example, the first rendering configuration 310 may comprise one or more clip plane settings positioned appropriately along with appropriate transfer function settings to allow some particular internal structure of the heart to be seen in detail.

In some examples, the parameters defining the first rendering configuration 310 may be set manually by a user. Additionally, or alternatively, the setting of one or more of the parameters defining the first rendering configuration 310 may be done automatically, for example, based on auto-created landmarks and/or auto-contouring, that is, automatic identification of structures in the volumetric dataset corresponding to particular structures of the medical volume. Optimizations of the rendering parameters may, for example, use differentiable rendering methods.

In a second step, a first set of multiple images 320 of the first rendering configuration 310 are rendered using the rendering parameters set in the first step. These images 320 are generated to cover a range of different viewing directions from which the first rendering configuration 310 may be viewed. The images 320 may be rendered as high-resolution images, e.g., rendered using a physically based path-tracing process. In examples where auto-created landmarks or features identified by auto-contouring are present, the viewing directions may be optimized to display these landmarks or features in an optimal way. For example, the set of images 320 may include multiple zoom level renderings of certain features of interest in the volumetric dataset. The rendering parameters used to render the set of images 320 may be stored in association with each rendered image along with any information specific to a particular one of the rendered images 320, such as camera position and direction.

In a third step, a first set of functions 330 representing the first rendering configuration 310 is created from the rendered images 320. The first set of functions 330 may be configured to provide an approximation of the volumetric dataset in the first rendering configuration 310. Each function of the first set of functions 330 may have a 3D location with respect to the volumetric dataset and has one or more visual attribute values, such as a shape, color and opacity. In one particular example, the functions of the first set of functions 330 are Gaussian functions such that the first set of functions 330 forms a first Gaussian splat representation representing the volumetric dataset in the first rendering configuration 310. In certain examples, additional compression may be performed to reduce the storage size of the first set of functions 330.

In addition to generating the first set of functions 330, one or more additional sets of functions, e.g. additional respective Gaussian splat representations, are generated. Each of these further sets of functions may be generated in the same manner as that described above for the first set of functions 330. For example, an additional set of functions may be generated which is configured to represent a particular region of interest of the volumetric dataset. This region of interest may be within the portion of the volumetric dataset represented by the first set of functions 330. For example, the region of interest may represent a part of the medical volume which it is desired to visualize close-up, in detail.

In the example shown in FIG. 3, a region of interest 345 of the volumetric dataset is identified to be represented with an additional set of functions. In some examples, the region of interest 345 may be a region which it is desired to represent at a higher resolution than that at which the volumetric dataset was represented in the first rendering configuration 310 represented by the first set of functions 330. In some examples, the region of interest 345 may be identified by a user. In other examples, the volumetric dataset may already comprise representations of different regions of interest which may be represented at higher resolutions. For example, where the volumetric dataset has been generated by a hierarchical imaging process in which the volumetric dataset comprises volume data arranged in a hierarchy with regions of interest scanned at increasing resolution, such as in hierarchical phase-contrast CT imaging.

The first, second and third steps described above may then be to generate a second set of functions 360 representing the region of interest 345. That is, a second rendering configuration 340 is defined with an appropriate set of rendering parameters for rendering images of the region of interest 345, e.g., at high resolution. A second set of images 350 is generated by performing the rendering process, which may have any of the features described above in relation to the rendering process used to generate the first set of images 320. For example, the rendering process may be a physically based rendering process capable of generating high-resolution images of the region of interest 345. The rendering parameters are stored in association with the second set of images 350. The second set of functions 360, e.g., a second Gaussian splat representation, is generated from the second set of images 350. These steps may be repeated for any further regions of interest within the volumetric dataset.

The first set of functions 330 and the second set of functions 360, and any other generated sets of functions representing further regions of interest, are used to determine given functions 380 to be stored in a representation 370 of the volumetric dataset. The given functions 380 are stored in the representation 370 in association with selection data. In the example shown in FIG. 3, all of the functions of the different sets of functions 330, 360 are determined as given functions 380 to be stored in the representation 370. In other examples, only a subset of the functions of the sets of functions 330, 360 may be selected to be stored as functions 380 in the representation 370. In yet other examples, the stored functions 380 may be determined by blending or otherwise combining functions from the different sets of functions 330, 360.

The representation 370 is configured to be used to render images of the volumetric dataset using a further rendering process. For example, functions may be selected from the stored function 380 based on the selection data and used in a rasterization process to render images of the volumetric dataset. The selection data may, for example, be indicative of the respective bounding box settings, resolution information and any other relevant information used to generate the images 320, 350 from which a particular one of the sets of functions 330, 360 was generated.

In some examples, the functions 380 are stored in the representation 370 in a hierarchical manner. In such examples, the selection data may be indicative of a level in the hierarchy to which a particular function corresponds. For example, the first set of functions 330 may represent an entirety of the volume at a first, lowest, resolution. The functions of the first set of functions 330 may be labelled accordingly in the representation 370 as belonging to a first level in the hierarchy. The second set of functions 360 may represent the region of interest 345 at a second resolution higher than the first resolution. The functions of the second set of functions 360 may be labelled accordingly as belonging to a second level in the hierarchy. In some examples, there may be further regions of interest at the second level in hierarchy. There may also be further levels in the hierarchy representing one or more further regions of interest at increasing resolution.

Such a hierarchical representation may be used to render an image of the volumetric dataset from any arbitrary viewpoint in an interactive manner. For example, when a given view for an image to be rendered using the further rendering process allows the entirety of the volume to be visualized, the first set of functions 330 labelled as belonging to the first level in the hierarchy may be selected from the stored functions 380 and used to render an image of the entirety of the volume from the given viewpoint. If the user changes the view for the image to be rendered such that it focuses on the region of interest 345, at the second level in the hierarchy, then the second set of functions 360 are selected from the stored functions 380 and used in the further rendering process to render an image of the region of interest 345 at the higher resolution.

In some examples, a zoom level may be used to determine the appropriate level in the hierarchy from which to select the functions to be used in rendering the image using the further rendering process. In certain examples, the visualization may allow a smooth transition between different levels in the hierarchy by blending images rendered by functions of different levels in the hierarchy. For example, when a user zooms into the region of interest 345, the zoom level may be used to smoothly blend between an image of the entirety of the volume generated by functions corresponding with the first set of functions 330 at the first level in the hierarchy (e.g., a lower resolution image) to an image of the region of interest 345 generated with functions corresponding to the second set of functions 360 at the second level in the hierarchy (e.g., a higher resolution image). In some examples, regions of interest, such as the first region of interest 345, represented with further sets of functions may be marked in the visualization to allow their identification by a user. For example, regions of interest may be marked by a particular color or encapsulated by a box.

Further parameter settings corresponding to different rendering configurations may be represented by different subsets of functions in the representation 370 in association with appropriate selection data. For example, multiple rendering configurations may be defined which differ only with respect to clip plane position. The positions of the clip planes might be defined manually by a user during key frame generation or auto-selected during based on segmentation, landmark information, or use-case specific optimal clip-plane positioning. For example, in a cardiac workflow, the clip plane might be auto positioned using segmentation information or anatomical landmarks, to reveal the ventricles or the heart valves. Each of these rendering configurations may be represented with a respective set of functions. These respective sets of functions may be generated in a manner similar to that described above with reference to the first or second sets of functions 330, 360 and stored in the representation 370 in association with appropriate selection data. For example, where a clip-plane position differs between the rendering configurations, the respective clip plane settings may be stored in association with the sets of functions in the representation 370. When using a further rendering process to render an image from the representation 370, an adjustment of the clip plane setting to be visualized by a user may allow for the appropriate set of functions representing that clip plane setting to be selected from the functions stored in the representation 370.

In some examples, rather than storing all of the functions representing the different parameter settings in the representation 370, a subset of these sets of functions may be selected to be stored in the representation 370. For example, the functions of the sets of functions representing the different parameter settings, e.g., different clip plane settings, may be compared with each other to identify functions which are shared among the parameter settings. This may comprise, for example, comparing functions of different parameter settings with one another using a similarity metric. Functions which are shared among the different parameter settings may be marked as global and may be stored in the representation 370 as belonging to a global set of functions. Additionally, one or more respective further sets of functions corresponding to each of the parameter settings may be stored in the representation 370. Each of these sets may represent a difference between the set of functions representing the respective parameter setting and the global set of functions. For example, for a given clip-plane setting only those functions which differ sufficiently from a function of the global set of functions may be stored in the representation 370. These functions may be stored in association with a label indicative of the clip-plane setting to which they correspond. Each different parameter setting may therefore be represented in a compact manner by storing in the representation 370, in addition to the global set of functions, only those functions which differ sufficiently from the functions of the global set.

In such an example, when rendering an image of the volumetric dataset with a given parameter setting, e.g., clip-plane position, all of the functions of the global set may be selected as well as those stored for the given parameter setting. This may allow for the process of rendering an image from the representation 370 to be more efficient, since the functions of the global set may be reused between parameter settings. For example, adjusting a parameter setting of the visualization, e.g., moving a clip plane, may involve loading into memory the subset of functions representing the new parameter setting in place of the subset of functions representing the previous parameter setting. This may be more efficient than loading into memory an entirely new set of functions corresponding to the new parameter setting. As an example, such a technique may allow the representation 370 to provide an interactive rendering process in an efficient manner. For example, the method may be able to provide, in an efficient manner, a visualization involving interactively melting a clip plane through the volume.

As an alternative to determining a global set of functions, all of the functions representing an initial parameter setting, e.g., an initial clip plane setting, may be stored in the representation 370. For example, each of multiple sets of functions corresponding to different parameter settings may be compared with the set of functions representing the initial parameter setting. Then, for each of these further parameter settings, only the functions which differ sufficiently from the functions in the initial set may be stored.

Similar techniques as those described above in relation to representing different rendering parameter settings may be used to represent different timesteps in a 4D volumetric dataset. For example, respective sets of functions may be generated to represent different timesteps of a 4D volumetric dataset. These sets of functions may be stored in association with selection data indicative of the timestep to which they correspond in the representation 370. In some such examples, techniques such as those described above may be used to encode the different timesteps in an efficient manner. For example, a set of functions which is shared among all of the functions of the different timesteps may be stored as a global set of functions with each of the timesteps being encoded based on their difference to the global set of functions. Alternatively, all of the functions representing a first timestep may be stored with other timesteps being represented by only those functions which differ from those of the first timestep.

In some examples, particular functions may be encoded with differential values representing a difference between the function and a reference function, for example, a function from an earlier timestep or a function at a different level in a hierarchy. In some such examples, each of the stored functions 380 may be encoded with an additional value representing a link to a reference function. Further, in some examples, during rendering, a particular function may be morphed using interpolation to allow a smooth transition from one rendering configuration to another, e.g., from one timestep to another or from one level in the hierarchy to another.

Any of these techniques may be used in combination with each other. For example, in examples as described above where a hierarchical representation of a volumetric dataset in a particular rendering configuration is generated, the functions stored for the different levels in the hierarchy may use a technique of encoding a global set of functions along with a different set of functions for each level in the hierarchy, or a technique of encoding a full representation of a given level in the hierarchy and for other levels in the hierarchy only encoding a difference to those encoded for the given level.

In some examples, the process of generating the images 320, 350 and respective sets of functions 330, 360 for representing different rendering configurations may involve techniques to reduce the amount of processing to be done. For example, where the different rendering configurations represent different positions of a clip-plane, a set of combinations of clip-plane position and target view can be determined to be used to generate the images for generating the functions to be stored in the representation 370. One such set of combinations is all possible combinations of clip-plane position and target view. However, it may be the case that not all of the clip-plane positions affect the image generated for a given target view. For example, for a given one of the set of target views the surface affected by the clip plane may not be visible, e.g., due to being occluded by other structures in the volume. As such, for this target view, changing the clip-plane position slightly may not affect the final rendered image. Such combinations of target view and clip plane may be omitted from the set of combinations to be used for rendering images. Images may then be generated for the determined set of combinations of clip-plane position and target view. This may allow for improved efficiency in the process of generating the representation 370 since the number images to be rendered for generating the functions to be stored in the representation 370 is reduced. These images then may be used to generate a set of functions to be stored in the representation 370 of the volumetric dataset, in the manner described above. In one such example, the generating of the functions, e.g., training of a Gaussian splat representation, involves iteratively training the sets of functions, using differentiable rendering, to accurately represent the clipped target views when applying the same clip-plane position.

Example methods described herein may be used in various scenarios where it is desirable to allow images of volumetric dataset to be generated in an interactive manner without distributing the volumetric dataset itself. This may allow for high-quality images to be rendered in an interactive manner while limiting the required computational power and/or storage requirements for a device to render the images. Further, by not distributing the volumetric dataset itself, protection of the source data of the volumetric dataset is provided for.

As an example, in a teacher-student scenario, a teacher may have prepared anatomical volume data, e.g., from a CT-scan, with optimal key frames for visualizing various anatomical structures and pathologies. For example, the teacher may set optimal transfer function and clip-plane settings for visualizing these structures and pathologies. For each of these key frames, according to methods described herein, a representation 370 may be generated as described above and distributed to the students for learning and exploration at home on a webpage, social media or personal mobile or immersive display device. For example, students may generate, using the representation 370, high-quality images of the key frame from any arbitrary viewpoint and may also change certain parameter settings of the rendering, such as clip-plane position, to provide an interactive visualization. This may allow for deepening the learning experience.

As another example, in a clinical setting, a radiologist and a surgeon might work together to generate one or more key frames with optimized parameters to view the particular pathology. This may be done on a high-powered rendering apparatus, e.g., in a desktop application. A representation 370 of these key frames may then be generated according to methods described above. This representation 370 may then be transferred to a viewing device in the operating room, e.g., a tablet computer, stereo display, AR glasses, or the like, to allow a high-quality interactive visualization to be generated for use in the operating room.

As yet another example, the representation 370 might be transferred to the local storage of an AR device. The AR device may then render images from the representation 370, using minimal bandwidth, storage and rendering power requirements, allowing the visualization to be interactively explored.

In certain examples, additional functions for the representation 370 may be transferred on demand, for example, if parameter settings are changed or if a region of interest or higher resolution region is explored by the user interactively exploring the visualization.

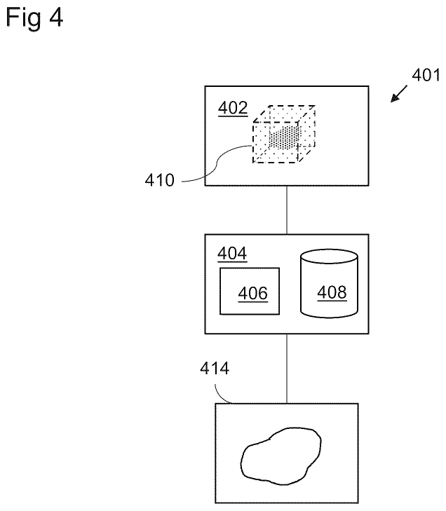

FIG. 4 is a schematic drawing illustrating an example system 401 in which an example apparatus 404 may use methods described herein. The system 401 comprises a scanner 402, the apparatus 404, and a visualization unit 414. In examples, the system may comprise fewer components than or additional components to those illustrated in FIG. 4. For example, the system 401 may comprise a computer network such as the internet.

The scanner 402 may be any scanner for generating a dataset comprising a volumetric dataset 410, which may, for example, be a medical volumetric dataset representing a portion of a patient. The scanner 402 may be a computed tomography (CT) scanner, a magnetic resonance imaging (MRI) scanner, a positron emission tomography (PET) scanner, an ultrasound scanner or the like. The scanner 402 is connected to the apparatus 404, for example via wired or wireless connection. The scanner 402 may be arranged to provide the volumetric dataset 410 to the apparatus 404.

The apparatus 404 comprises one or more processors 406 and a memory, in the form of one or more storages 408. The apparatus 404 may, for example, comprise a GPU. In this example, the apparatus 404 is arranged to perform a method according to examples described above of generating a representation of the volumetric dataset 410 for use in rendering images of the volumetric dataset 410. The apparatus 404 may for example, comprise one or more processors for performing the various aspects of the method. For example, the apparatus 404 may comprise a volume rendering module to perform a process of rendering the images used to generate the representation of the volumetric dataset 410, e.g. by performing a physically based volume rendering process on the volumetric dataset 410 with different rendering parameter settings.

The storage 408 may comprise a machine-readable medium comprising a set of machine-readable instructions which when executed by the processor 406 cause the apparatus 404 to perform an example method described herein. The program may be stored on a computer readable medium which may be read by the apparatus 404 to thereby execute the program. The apparatus 404 may be arranged to receive directly or indirectly or otherwise acquire from the scanner 402 the volumetric dataset 410. The apparatus 404 may be configured to use the volumetric dataset 410 to render images and to use those images in a method as described above to generate a representation of the volumetric dataset. In other examples, the scanner 402 may be omitted and the volumetric dataset 410 may obtained from an external source.

The apparatus 404 may be arranged to transmit information, for example, values defining the representation of the volumetric dataset 410, for example, a Gaussian splat representation including associated selection data, to a visualization unit 414. The transmission may be direct or indirect, for example via a wired connection, a wireless connection, or via the internet.

The visualization unit 414 may comprise visualization software for displaying a two-dimensional projection of the volumetric dataset 410 using the representation generated by the apparatus 404. For example, the visualization unit 414 may comprise apparatus for performing a rendering process, e.g., a rasterization process, to interactively render images from the representation of the volumetric dataset 410. The visualization unit 414 may comprise a display screen, and one or more graphics hardware or software components. In some examples, the visualization unit 414 may be or comprise a mobile device. In some examples the visualization unit 414 may comprise a virtual reality or augmented reality device. The visualization unit 414 may in some examples display a stereo image. In yet other examples, the apparatus 404, or another apparatus intermediate the apparatus 404 and the visualization unit 414, may perform a rendering process on the representation and provide the generated data for visualizing the images to the visualization unit 414 for display.

While in certain examples described above, the functions stored in the representation of the volumetric dataset are Gaussian functions, in other examples, the functions may be of a different type, for example, the functions may represent one or more neural radiance fields.

In certain examples described above the method of generating the representation of the volumetric dataset involves performing a rendering process to render the images of the volumetric dataset in the different rendering configurations which are used to generate the representation. However, in other examples, the images to be used to generate the representation may be obtained from another source, e.g., from an external rendering apparatus or from a suitable storage storing pre-rendered images of the volumetric dataset in different rendering configurations.

The above embodiments are to be understood as illustrative examples of the invention. Other embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,“ ”connected,” “engaged,” “interfaced,” and “coupled. ” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,”etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A computer-implemented method of generating, for use in a rendering process, a representation of a volumetric dataset representing a medical volume, the method comprising:
generating a plurality of sets of functions representing a volumetric dataset in different respective rendering configurations;
determining, based on the plurality of sets of functions, given functions having a respective 3D location with respect to the volumetric dataset and a respective one or more visual attribute values to be stored in a representation of the volumetric dataset to be used in a rendering process; and
storing, in the representation of the volumetric dataset, the given functions in association with selection data configured to allow selection, during the rendering process, of one or more of the given functions for use in the rendering process, wherein the selection data is based on one or more of the rendering configurations.

2. The method of claim 1, wherein the different rendering configurations comprise a first rendering configuration representing a first portion of the volumetric dataset at a first resolution, and a second rendering configuration representing a second portion of the volumetric dataset at a second resolution higher than the first resolution, the second portion of the volumetric dataset being different than the first portion of the volumetric dataset.

3. The method of claim 1, wherein the given functions are Gaussian functions and the representation of the volumetric dataset is a Gaussian splat representation.

4. The method of claim 1, wherein one or more of the different rendering configurations differ with respect to one another with respect to one or more of:
a clip plane setting;
a transfer function setting;
a lighting setting; and
a bounding box setting.

5. The method of claim 1, comprising:
comparing one or more functions of different sets of the plurality of sets of functions; and
wherein the determining the given functions to be stored in the representation of the volumetric dataset is based on a result of the comparing.

6. The method of claim 5, wherein the comparing comprises:
determining respective similarities between functions of the different sets of functions and the determining the one or more given functions is based on the determined similarities.

7. The method of claim 1, wherein the volumetric dataset is a 4D volumetric dataset and the different rendering configurations represent different timesteps of the 4D volumetric dataset.

8. The method of claim 1, wherein the generating the plurality of sets of functions comprises:
generating each set of the plurality of sets of functions based on a respective plurality of rendered images showing from different viewpoints the volumetric dataset in a given rendering configuration.

9. The method of claim 8, further comprising:
generating the plurality of sets of rendered images using a respective rendering process having one or more respective rendering parameters.

10. The method of claim 8, comprising:
determining combinations of viewpoint and respective rendering configurations of the different rendering configurations, the combinations are configured to provide images which differ from one another with respect to a visible aspect of the volumetric dataset, when used in the rendering process; and
determining, based on the determined combinations, the respective different viewpoints for the respective plurality of images showing the volumetric dataset in the given rendering configuration.

11. The method of claim 8, wherein one or more of the respective rendering processes is a physically based rendering process.

12. A computer-implemented method of rendering an image of a volumetric dataset representing a medical volume, the method comprising:
performing a rendering process using a representation of a volumetric dataset representing a medical volume, the representation of the volumetric dataset comprising given functions having a respective 3D location with respect to the volumetric dataset and a respective one or more visual attribute values;
wherein the given functions are stored in the representation in association with selection data configured to allow selection of one or more of the given functions for use in the rendering process during the rendering process; and
wherein the rendering process includes,
selecting, based on the selection data and one or more parameters of the rendering process, one or more functions of the given functions for use in the rendering process, and
rendering an image of the volumetric dataset using the selected one or more functions of the given functions.

13. A non-transitory computer-readable medium comprising instructions which when executed by a system cause the system to perform the method of claim 1.

14. A non-transitory machine-readable medium comprising:
a representation of a volumetric dataset representing a medical volume, the representation being generated by the method of claim 1.

15. An apparatus comprising:
a processor; and
a storage including,
a representation of a volumetric dataset representing a medical volume, the representation being generated by the method of claim 1.

16. The method of claim 9, further comprising:
determining the selection data based on one or more of the respective rendering parameters.

17. The method of claim 6, wherein the volumetric dataset is a 4D volumetric dataset and the different rendering configurations represent different timesteps of the 4D volumetric dataset.

18. The method of claim 17, wherein the generating the plurality of sets of functions comprises:
generating each set of the plurality of sets of functions based on a respective plurality of rendered images showing from different viewpoints the volumetric dataset in a given rendering configuration.

19. The method of claim 9, comprising:
determining combinations of viewpoint and respective rendering configurations of the different rendering configurations, the combinations are configured to provide images which differ from one another with respect to a visible aspect of the volumetric dataset, when used in the rendering process; and
determining, based on the determined combinations, the respective different viewpoints for the respective plurality of images showing the volumetric dataset in the given rendering configuration.

20. The method of claim 19, wherein one or more of the respective rendering processes is a physically based rendering process.
